(19) United States
(12) Patent Application Publication
(10) Pub. No.: US 2003/0086774 A1
(43) Pub. Date: May 8, 2003

(54) System and method for inhibiting motion of semiconductor wafers in a variable-pressure chamber

(75) Inventor: Neil S. Casa, Arlington, MA (US)

Correspondence Address: Thomas Langer, Esq., Cohen, Pantani, Lieberman & Pavane, 551 Fifth Avenue, Suite 1210, New York, NY, 10176, US

(73) Assignee: SCHLUMBERGER TECHNOLOGIES, INC., San Jose, CA

(21) Appl. No.: 10/007,618

(22) Filed: Nov. 7, 2001

(51) Int. Cl. B65G 1/00

(52) U.S. Cl. 414/217

(57) ABSTRACT

Semiconductor wafers are held in position within a transfer chamber as it is subjected to pressurization and depressurization during transfer of the wafers between ambient atmosphere and an inspection chamber which is maintained at vacuum pressure. The transfer chamber is interposed between the ambient atmosphere and the inspection chamber. A paddle is arranged in the transfer chamber and has a wafer-receiving surface with openings formed therein adapted to be covered by a wafer. A vacuum actuated system draws the wafer to the wafer-receiving surface of the paddle by providing suction at the openings. Since the wafer is thus drawn to the paddle, the wafer is securely retained on the paddle during depressurization and repressurization of the transfer chamber. To further inhibit motion during repressurization, gas is backfilled into the transfer chamber through a diffuser as a laminar flow.

### FIELD OF THE INVENTION

The invention is directed to a system and method for inhibiting motion of planar objects, such as semiconductor wafers, in a chamber subjected to alternating depressurization and repressurization and, more particularly, to a wafer holding system and method for securely holding wafers in a loadlock chamber during transfer of the wafers into and from an automatic metrology system operating in a vacuum via the loadlock chamber.

### BACKGROUND OF THE INVENTION

Imaging systems are used in such fields as microelectronics, medicine, biology, genetic engineering, mapping and even astronomy. The imaging device can be a suitable type of microscope or, in the case of astronomy, a telescope. The demand for image accuracy is high and, therefore, the influence of noise in a signal derived by the imaging system from an imaged object must be minimized.

For reasons of convenience and efficiency, the invention will be described in the microelectronics environment, although another environment could also have been chosen. During the manufacture of very large scale integration (VLSI) semiconductor devices, measurements are made at several stages of the manufacturing process to determine whether particular features on the object are within specified design tolerances. If not, then suitable corrective action is taken quickly.

As is well known, such a manufacturing process produces a wafer which is divided into dies. Each die has a large number of electronic components. These components are defined by what can generally be termed “features” in the sense that a feature is detectable by a microscope as a foreground element distinguishable from a background, or vice versa, and having a dimension such as width. To measure that width the edges of the feature must be located accurately. “Edge” is a term used to signify detectable discontinuities in a signal obtained by imaging the feature (in any environment, not only microelectronics). The goal of edge detection is to accurately locate the transitions despite the influence of blurring and the presence of noise.

As technology has succeeded to increase the component density per die, the feature dimensions have shrunk to significantly below a micrometer. Consequently, the measurement equipment must measure submicrometer dimensions with lower allowable error tolerances.

Automated systems have been developed for making these measurements to replace manual systems in order to obtain higher process yields, to reduce exposure of the wafers to contamination and to provide a higher throughput. One example of an automated system is disclosed in U.S. Pat. No. 4,938,600. As shown in FIG. 1 which is taken from that patent, and explained in greater detail below, an image of a feature is recorded through a microscope and the recorded image is then processed electronically to obtain the required measurements. One such automated system is the Model IVS-120 metrology system manufactured by Schlumberger Verification Systems of Concord, Mass., a division of Schlumberger ATE Products. The major elements of the system, including a wafer handler, an optical system and a computer system, are mounted in a cabinet (not shown).

The wafer handler includes a cassette wafer holder 112 which contains wafers to be measured, a prealigner 114, a wafer transport pick mechanism (e.g., robotic transfer arms, not shown) for moving the wafers and a measurement stage 118 which holds the wafers during the actual measurement operation. During operation, the wafer transport pick mechanism removes a wafer 116 from cassette 112 and places it on prealigner 114. Prealigner 114 then rotates wafer 116 to a predetermined orientation by sensing a mark, a flat spot or notched edge on wafer 116, after which the wafer transport pick mechanism transfers wafer 116 from prealigner 114 to measurement stage 118 and positions wafer 116 in a horizontal orientation. Stage 118 is movable in three dimensions for precisely positioning wafer 116 relative to the optical system for performing the actual measurement.

The optical system includes microscope 120 and video camera 122 positioned above the measurement stage 118 and wafer 116. Microscope 120 typically has a turret carrying several objective lenses providing a desired range of magnification and is mounted so that microscope 120 and camera 122 have a vertical optical axis which is perpendicular to the wafer surface.

A feature to be measured on wafer 116 is located with microscope 120 in a well known manner by the movable measurement stage 118 until the feature is in the field of view of the objective lens. The optical system is focused, and a focused image of the feature is digitized and recorded by the camera 122. The image is then stored or “frozen”.

The system is controlled by a computer 130. Coupled to the computer 130 are a monitor 132 for display of the image recorded by the camera 122 and text, and a keyboard 136 (which constitute an input terminal for entering operator commands) and a disk drive 138 for storing system software and data.

Image processor 128 uses software algorithms to locate the edges of the selected feature and make a measurement. Computer 130 then displays the measurement data on screen, prints a hard copy or transfers the data directly to a host computer (not shown) for centralized data analysis. Once the process is complete, wafer 116 is returned to cassette 112 by the wafer handler.

One modification to the above system entails placement of the measurement stage in a vacuum chamber which is maintained at vacuum pressure. Since the cassette 112 is usually in the ambient atmosphere, one or more chambers, often referred to as loadlock chambers, are interposed between the ambient atmosphere and the vacuum chamber for facilitating transfer of the wafers between the vacuum chamber and the ambient atmosphere. The loadlock chamber is alternatingly pressurized and depressurized. It is depressurized to the vacuum pressure in the vacuum chamber in order to enable transfer of an incoming, uninspected wafer from the loadlock chamber to the vacuum chamber, and transfer of an inspected, outgoing wafer from the vacuum chamber to the loadlock chamber. It is repressurized to atmospheric pressure in order to enable transfer of an inspected, outgoing wafer from the loadlock chamber to the ambient atmosphere and transfer of an incoming wafer from the ambient atmosphere to the loadlock chamber. To this end, gate valves are associated with each loadlock chamber to isolate the vacuum environment from the ambient atmosphere during the transfer of the wafers between the vacuum chamber and the ambient atmosphere. While in the loadlock chamber, the wafers are usually placed on paddles, or pedestals.

One problem arising from the placement of the measurement stage in a vacuum chamber and the attendant need to operate loadlocks for facilitating transfer of wafers between the ambient atmosphere and the vacuum chamber is a reduction in throughput. Specifically, the processing time for obtaining measurements of the wafers has increased in view of the time required to depressurize, or pump down, the loadlock chamber to the pressure level of the vacuum chamber to enable the transfer of wafers between the loadlock chamber and the vacuum chamber and then to repressurize, or pump up, the loadlock chamber to the pressure level of the ambient atmosphere to enable the transfer of wafers between the loadlock chamber and the ambient atmosphere.

Moreover, the depressurization and repressurization of the loadlock chamber often causes the wafers to move on the paddles. This can disrupt the transfer of the wafers because the wafers must be positioned precisely in the loadlock chamber so that they can be grasped and accurately positioned in the vacuum chamber by the robotic transfer arms. In particular, when gas is pumped out of the loadlock chamber, a turbulent gas flow occurs as the pressure in the loadlock chamber is abruptly reduced from atmospheric pressure, and this turbulent gas flow is liable to cause unintended and undesirable motion of the wafer. When gas is pumped back into the loadlock chamber, there is a sudden inflow of gas which is also capable of moving the wafer. The prior art approaches to avoid this problem have slowed down the pumping of gas both into and from the loadlock chamber in such a way as to avoid violent air flows which could cause the wafers to move. Unfortunately, this slowdown of the pumping tends to further reduce the throughput of wafers.

### OBJECTS AND SUMMARY OF THE INVENTION

Accordingly, one object of the present invention is to provide a new and improved system and method for inhibiting unintended motion of planar objects, such as semiconductor wafers, while the wafers are in a transfer or loadlock chamber which is subjected to alternating depressurization and repressurization.

A further object of the present invention is to provide a new and improved wafer holding system and method for securely holding wafers on paddles in a loadlock chamber during transfer of the wafers into and from an automatic metrology system operating in a vacuum via the loadlock chamber while preventing unintended motion of the wafers on the paddles during depressurization and repressurization of the loadlock chamber.

Another object of the present invention is to provide a new and improved wafer transfer system and method for transferring wafers through a loadlock chamber in which depressurization and/or repressurization of the loadlock chamber is controlled with a view toward preventing unintended motion of wafers located therein during such depressurization or repressurization.

Yet another object of the present invention is to provide a new and improved wafer transfer system and method for transferring wafers through a loadlock chamber in which the throughput of the wafers is increased, without it causing problematic motion of the wafers that are positioned on paddles within the chamber, by reducing the time for depressurizing and repressurizing the loadlock chamber.

These and other objects are attained in accordance with one aspect of the present invention directed to a semiconductor wafer holding system for holding wafers in position within a transfer chamber during transfer of the wafers between ambient atmosphere and an inspection chamber which is at vacuum pressure. A transfer chamber is interposed between the ambient atmosphere and the inspection chamber and subjected to alternating depressurization and repressurization. At least one paddle is arranged in the transfer chamber, and having a wafer-receiving surface having with openings therein adapted to be covered by a wafer. A drawing means is provided for drawing the wafer to the wafer-receiving surface of the at least one paddle to thereby inhibit motion of the wafer in the transfer chamber during at least one of the pressurization and depressurization.

Another aspect of the present invention is directed to a semiconductor wafer holding system for holding wafers in position during transfer of the wafers between ambient atmosphere and an inspection chamber which is at vacuum pressure. A transfer chamber is interposed between the ambient atmosphere and the inspection chamber and subjected to alternating depressurization and repressurization. A paddle is arranged in the transfer chamber, and having a wafer-receiving surface with openings therein adapted to be covered by a wafer. A conduit couples a vacuum source or pump in flow communication with the openings. At least one valve is operatively arranged in the conduit, whereby actuation of the at least one valve controls the flow communication so that when the pressure at the openings is less than the pressure prevailing in the transfer chamber, the wafer is drawn to the wafer-receiving surface of the paddle to thereby inhibit motion of the wafer in the transfer chamber.

A further aspect of the present invention is directed to a method for inhibiting motion of a semiconductor wafer in a transfer chamber subjected to alternating depressurization and repressurization. A paddle is arranged in the transfer chamber, the paddle having a wafer-receiving surface with openings therein. The wafer is placed on the wafer-receiving surface of the paddle, and over the openings. The openings are coupled in flow communication with a vacuum source or pump, and flow communication between the vacuum source or pump and the openings is controlled during at least one of the depressurization and repressurization of the transfer chamber to cause the wafer to be drawn to the wafer-receiving surface of the paddle by a vacuum force and thereby inhibit motion of the wafer in the transfer chamber.

Yet another aspect of the present invention is directed to a semiconductor wafer holding system for holding wafers in a transfer chamber during transfer of the wafers between ambient atmosphere and an inspection chamber which is at vacuum pressure. A transfer chamber is interposed between the ambient atmosphere and the inspection chamber and subjected to alternating depressurization and repressurization. A paddle is arranged in the transfer chamber, said paddle having a wafer-receiving surface. A laminar flow means is provided for introducing a laminar flow of gas into the transfer chamber to repressurize the transfer chamber to thereby inhibit motion of any wafers during repressurization.

One other aspect of the present invention is directed to a method for inhibiting motion of a semiconductor wafer in a transfer chamber during repressurization of the transfer chamber. A paddle is arranged in the transfer chamber, and the wafer is placed on a wafer-receiving surface of the paddle. A laminar flow of gas is introduced into the transfer chamber during repressurization of the transfer chamber to thereby inhibit motion of the wafer during repressurization of the transfer chamber.

### BRIEF DESCRIPTION OF THE DRAWINGS

These and other objects, aspects and features of the invention will be more clearly understood when the following detailed description is read in conjunction with the attached drawings, wherein:

FIG. 1 is a block diagram of a prior art automated measurement system for providing optical measurements of a semiconductor device;

FIG. 2 is a plan view of an automated measurement system in which the method and apparatus in accordance with the invention can be applied;

FIG. 3 is a schematic diagram including a cross section of a loadlock chamber taken along line 3-3 in FIG. 4 arranged in accordance with the principles of the present invention;

FIG. 4 is a cross section taken along line 4-4 in FIG. 3; and

FIG. 5 is a schematic diagram of a system arranged in accordance with the principles of the present invention.

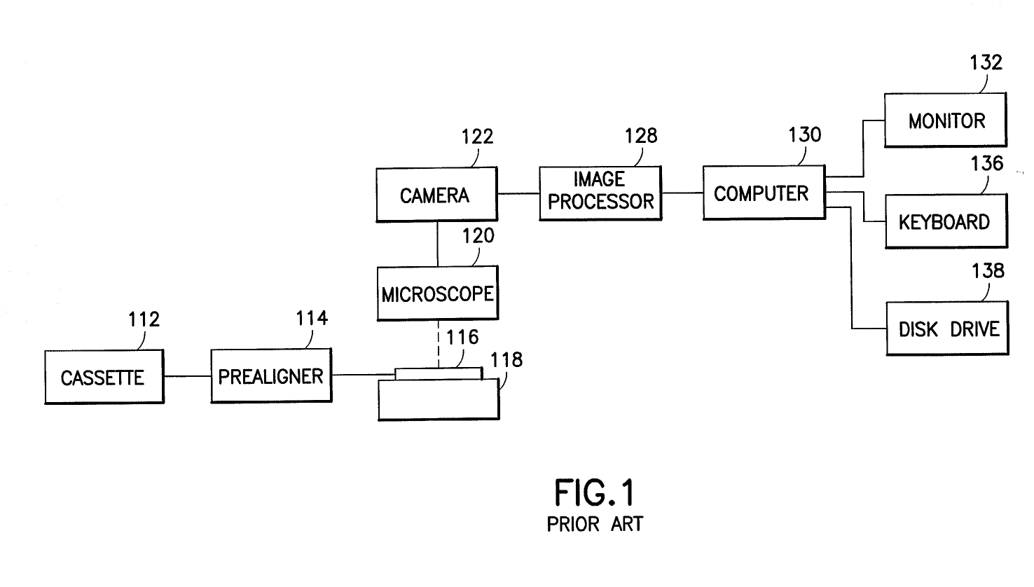

### DETAILED DESCRIPTION OF THE DRAWINGS

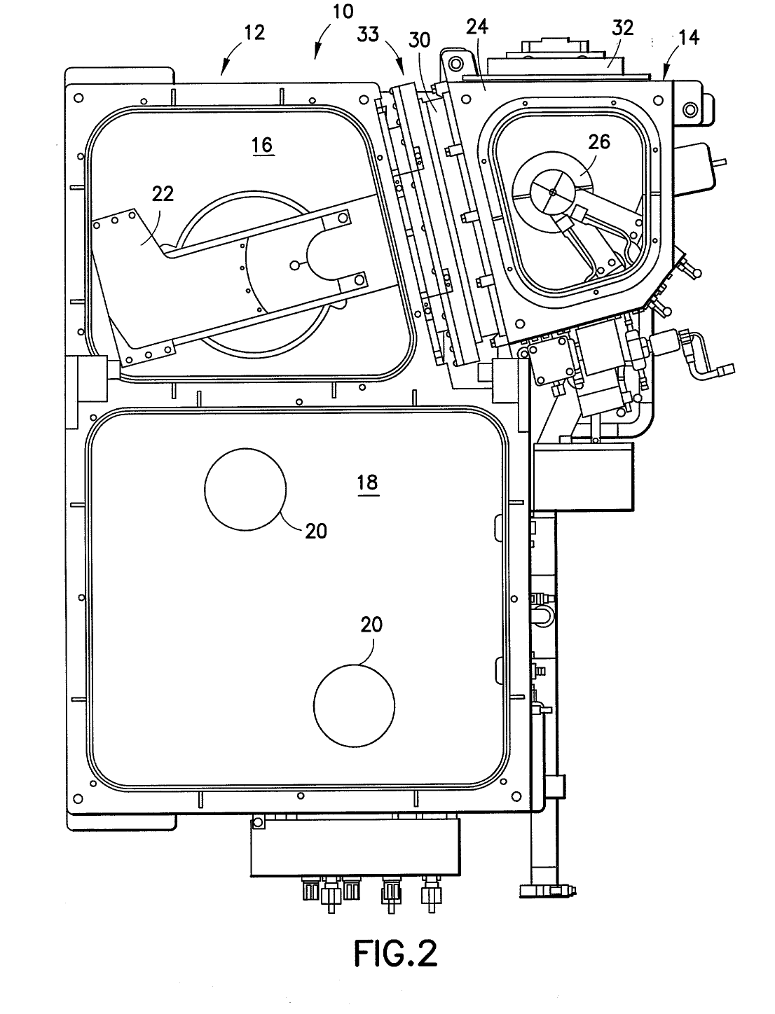

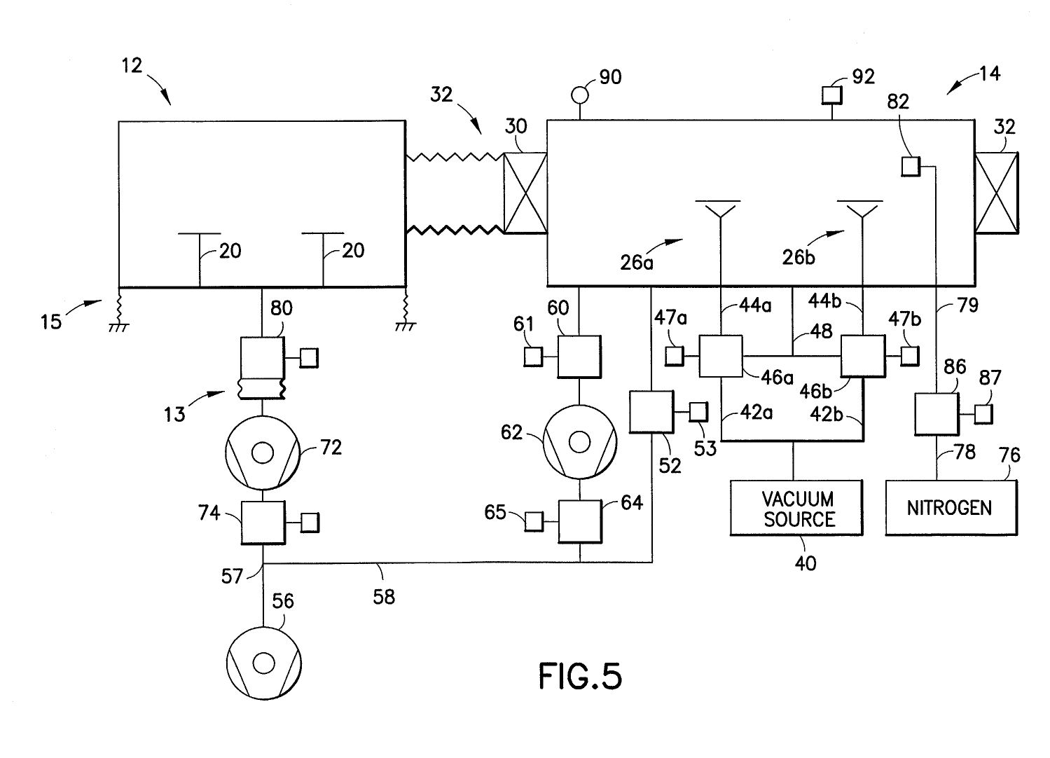

Referring first to FIG. 2, an automated measurement system in which the invention can be applied is generally designated 10 and includes an inspection chamber 12 and a loadlock chamber 14. Inspection chamber 12 has a transfer portion 16 and an inspection or measurement portion 18 having a pair of measurement sites 20. A measurement device (not shown) performs a measurement or inspection of the wafers when the wafers are situated at the measurement sites 20. Inspection chamber 12 is maintained at high vacuum (e.g., 10E-6 Torr). The inspection chamber 12 is also mounted on a vibration isolation system 15 (see FIG. 5) to cancel environmental vibration and other vibrations resulting from movement of the components of the measurement system. Details of the vibration isolation system are not provided because such systems are well known and, further, because it forms no part of the present invention. Since the loadlock chamber is fixed to a support frame 24, a floating coupling 33 is provided between the inspection chamber 12 and the loadlock chamber 14, and a floating coupling 13 (see FIG. 5) is in place between chamber 12 and the pumps, as explained below. Details of the floating coupling 33 are set forth in co-pending application Ser. No. ______ filed ______ (Attorney Docket No. 00244/TL) titled “Vibration-Isolating Coupling including an Elastomer Diaphragm for Scanning Electron Microscope and the like”. A robotic transfer arm 22 is situated in the inspection chamber 12 and transfers wafers between the loadlock chamber 14 and the measurement portion 18 of the inspection chamber 12.

Loadlock chamber 14 includes one or more pedestals, or paddles, on which wafers 28 are held during transfer of the wafers between the ambient atmosphere and the inspection chamber 12. At least two paddles 26 are typically provided so that as one receives an incoming wafer to be inspected, the other receives an outgoing wafer to be returned for further processing. Therefore, the following discussion will involve the use of two paddles 26a, 26b. For the sake of convenience, both paddles will be referred to below collectively by the numeral 26 unless reference to a particular one of paddles is necessary.

A first gate valve 30 is interposed between the inspection chamber 12 and the loadlock chamber 14 and a second gate valve 32 is interposed between the loadlock chamber 14 and the ambient atmosphere. Each gate valve 30, 32 is operable between an open position in which the atmospheres on the sides of the valve are in communication with one another and a closed position in which the atmospheres on the sides of the valve are isolated from one another. A cassette of wafers, a pre-aligner and possibly other wafer handling devices such as a robotic transfer arm (not shown) are situated outside of the second gate valve 32 to place wafers onto the paddles 26 and remove the inspected wafers therefrom.

A general description will first be provided, without including specific aspects of the present invention, to explain how the apparatus shown in FIG. 2 operates. This will be followed by a detailed explanation of features and of operations in accordance with principles of the present invention.

In operation, gate valve 30 is initially closed while gate valve 32 is opened, and a wafer is placed onto a paddle 26 in the loadlock chamber 14 through the gate valve 32 from the cassette (not shown) located in the ambient atmosphere. This is an atmospheric wafer exchange since the loadlock chamber 14 is at the same pressure as the ambient atmosphere. Gate valve 32 is then closed, the pressure in loadlock chamber 14 is brought to substantially the same vacuum level as prevails in inspection chamber 12, and the gate valve 30 is then opened. The transfer arm 22 removes the wafer from the loadlock chamber 14 and brings it into the transfer portion 16 of the inspection chamber 12. This is a vacuum wafer exchange since both the vacuum chamber 12 and the loadlock chamber 14 are at substantially the same vacuum pressure. Gate valve 30 is then closed, loadlock chamber 14 is repressurized, gate valve 32 is opened and another wafer is transferred from the cassette onto one of the paddles 26. During this repressurization and atmospheric wafer exchange, the transfer arm 22 moves the wafer that was brought into transfer portion 16 to a measurement site 20 in the measurement portion 18 to be inspected, and the inspection is performed. After another wafer is placed onto an available paddle in the loadlock chamber 14, gate valve 32 is closed, loadlock chamber 14 is depressurized and gate valve 30 is opened. The transfer arm 22 transfers the wafer from the measurement site 20 to the unoccupied paddle 26 in loadlock chamber 14 so that the loadlock chamber 14 will thus contain an incoming, uninspected wafer and an outgoing, inspected wafer. The transfer arm 22 then removes the incoming wafer from the loadlock chamber 14. Gate valve 30 is closed, loadlock chamber 14 is repressurized, and gate valve 32 is then opened. The inspected wafer is removed from the loadlock chamber 14 and another incoming, uninspected wafer is placed into the loadlock chamber 14. At the same time as the loadlock chamber 14 is being repressurized and the outgoing, inspected wafer is removed therefrom, the transfer arm 22 places the wafer it just removed from loadlock chamber 14 on a measurement site 20, and the wafer is inspected. This process is repeated until all the wafers in the cassette are inspected.

Before turning to a discussion of the features and operations of the present invention, the following factors must be appreciated. During the occurrence of an atmospheric wafer exchange, with gate valve 32 being open, the loadlock chamber 14 is at the ambient pressure. After gate valve 32 is closed, and prior to opening of the gate valve 30, the loadlock chamber 14 must be depressurized to approximately the very high vacuum maintained in chamber 12. During the depressurization, or pumping down, operation, i.e., when gas is removed from the loadlock chamber 14 after closing of gate valve 32 and prior to opening of gate valve 30, two types of gas flow are sequentially formed. The first type of gas flow is a turbulent gas flow which occurs as atmospheric pressure is pumped down and is greater than 10E-3 Torr, and the second type of gas flow is a molecular gas flow at pressures lower than 10E-3 Torr. The turbulent flow of gases due to the outrush of air during the initial stages of this depressurization creates forces within the loadlock chamber 14 sufficient to move the wafer present in the loadlock chamber 14 rotationally and/or laterally while it is seated on the paddle 26. Such motion can cause the wafer to be out of position for pickup by the transfer arm 22 and, even if pickup is possible, it can cause inaccurate readings to be made in the inspection chamber 12. The molecular gas flow cannot impart any motion to the wafer.

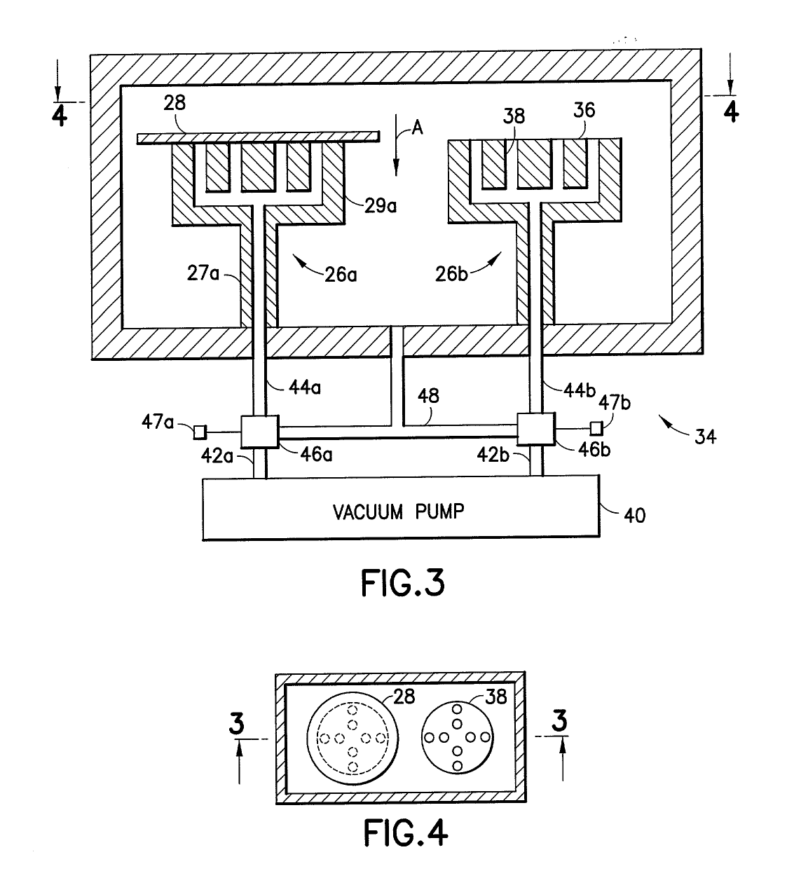

Referring now to FIGS. 3 and 4, in accordance with the invention, motion of the wafers on the paddles 26 during depressurization and repressurization of the loadlock chamber 14 is inhibited by providing vacuum actuated means 34 for drawing, or attracting, the wafer toward an upper surface 36 of the paddles 26 with a suction force. Paddle 26a is illustrated as having a vertical stand 27a and a flat, horizontal, round top 29a with upwardly facing wafer receiving surface 36. Paddle 26b is a duplicate of 26a.

In the illustrated embodiment, vacuum actuated drawing means 34 comprises openings 38 in the upper surface 36 of the paddles 26, a vacuum pump 40, and branch conduits 42a, 42b leading from the vacuum pump 40 to paddle conduits 44a, 44b arranged in the paddles 26 and terminating at openings 38. The sites of the openings 38 in the surface 36 are selected so that the openings 38 will be covered by a wafer 28 when the wafer is situated on the paddle 26. Also, conduits 48 lead from valves 46a, 46b to the interior of loadlock chamber 14.

A three-way valve 46 is interposed between the openings 38 in each paddle and the vacuum source 40 to enable selective on/off control of the suction force applied at the openings 38. Valve 46a is controlled by input 47a to communicate conduits 42a and 44a with each other so that a suction force is generated at the openings 38 of paddle 26a. As a result, the wafer 28 resting on the upper surface 36 of the paddle 26a is drawn toward the upper surface 36 as represented by arrow A in FIG. 3. This drawing or pulling force on the wafer serves to inhibit motion of the wafer during the depressurization and repressurization of the loadlock chamber 14. Control input 47a for valve 46a can be electrical or pneumatic in accordance with well known valve arrangements.

The suction force is generated at the openings 38 by the vacuum at least during the time period while the turbulent gas flow prevails in the loadlock chamber 14. In order to break the suction force, input 47a causes valve 46a to communicate conduits 44a and 48 with each other. As a result, the same pressure is applied above and below wafer 28 so that it is held in place on the paddle only by the force of gravity.

FIG. 5 depicts a more detailed schematic for the apparatus required to implement the present invention. The components in this drawing which are the same as those in FIG. 3 are identified with the same reference numeral. Thus, FIG. 5 includes chambers 12 and 14, gate valves 30 and 32, paddles 26a, 26b, valves 46a, 46b, and vacuum pump 40 along with their associated conduits as described above with respect to FIG. 3. In addition, FIG. 5 shows roughing pump 56 (the term “roughing”is a term of art referring to pressures above 10E-3 Torr) which provides vacuum pumping to chambers 12 and 14 via conduits 57 and 58, respectively. Roughing valve 52 is between roughing pump 56 and the interior of loadlock chamber 14. Turbo molecular vacuum pump 62 is communicable with roughing pump 56 via valve 64, and with the interior of loadlock chamber 14 via valve 60. Thus, pressure in loadlock chamber 14 is quickly reduced from atmospheric pressure to 10E-3 Torr by the roughing pump. Then, the turbo pump further reduces the pressure to 10E-6 Torr.

Another turbo molecular vacuum pump 72 is communicable with roughing pump 56 via valve 74, and with the interior of vacuum chamber 12 via valve 80. Pump 72 is always in communication with chamber 12 while the apparatus is in operation, and it acts to maintain a constant pressure of 10E-6 Torr in chamber 12. Chamber 12 is isolated from the various pumps by floating coupling 13 and the rest of the environment by vibration isolation system 15, as discussed above. Gate valve 30 is coupled to chamber 12 by floating coupling 33, as discussed above.

Valves 64 and 74 are in-line between conduit 58 and chambers 14 and 12, respectively. It must be noted that the pressure in line 58 rises to atmospheric pressure each time valve 52 is opened and chamber 14 is at atmospheric pressure. Valves 64 and 74 are used to isolate the turbo pumps 62 and 72 from conduit 58 at such times because, otherwise, the turbo pumps could be shut down and damaged by such pressure.

For repressurizing chamber 14, nitogen source 78 is provided which communicates with diffuser 82 within loadlock chamber 14 via valve 86 and conduits 78, 79. Details of the diffuser will be provided below in connecton with an explanation as to why and how it creates a laminar flow. Nitrogen gas is typically used for repressurizing chambers because of its well known advantageous characteristics for this task. Of course, other gases could also be used if preferred.

The apparatus of FIG. 5 is operated as follows in accordance with the present invention.

1. An atmospheric exchange is completed with gate valve 32 being open, as described above.

2. Gate valve 32 is closed.

3. Valves 46a and/or 46b are actuated to communicate vacuum source 40 with openings 38 of the corresponding paddle to create a suction force which draws the wafer toward the surface 36 by virtue of the pressure differential formed between the upper and lower surfaces of the wafer. Since it is necessary to open only the vacuum valve 46a, 46b associated with an occupied paddle, a sensor (not shown) is provided to determine whether a wafer is seated on a paddle, and suction is created only on whichever paddle has a wafer on it.

4. Valves 64 and 74 are closed.

5. Roughing valve 52 is opened to communicate roughing pump 56 with loadlock chamber 14. The roughing pump 56 is designed to very quickly evacuate the loadlock chamber 14. During this stage, a turbulent gas flow is created in the loadlock chamber 14 which could cause motion of the wafer on the paddle 26, but it does not because the wafer is held down by the suction applied to the lower surface of the wafer via the openings 38 in surface 36 of the paddles 26.

6. Pressure sensor 90 determines when a predetermined trigger pressure near 10E-3 Torr is reached in loadlock 14, and this causes a control signal to be generated to control input 53 of roughing valve 52 to close the roughing valve.

7. Valves 64 and 74 are opened.

8. Valves 46a and 46b are controlled to place the openings 38 in communication with conduit 48 so that pressure above and below the wafers is equalized. Although at this point the wafers are kept in place by the force of gravity alone, no movement thereof will occur because they will be exposed merely to molecular flow.

9. Turbo valve 60 is opened to communicate turbo molecular pump 62 with loadlock chamber 14 to further reduce the pressure therein to 10E-6 Torr.

10. Pressure sensor 90 determines when a predetermined trigger pressure close 10E-6 Torr is reached in loadlock chamber 14, and this cause a control signal to be generated which actuates gate valve 30 to open. There is usually a slight difference in pressure between the chambers 12 and 14 when the gate valve 30 is opened because throughput is deleteriously affected if chamber 14 were depressurized to equal the level of chamber 12. Thus, there will be some minimal molecular flow from the loadlock chamber 14 to the inspection chamber 12. However, this molecular flow is incapable of causing movement of the wafer on the paddles.

11. A vacuum exchange is completed with gate valve 30 being open, as described above.

12. Gate valve 30 is closed.

13. Valve 60 is closed.

14. Apply vacuum to the paddles from vacuum source 40 by opening valves 46a, 46b.

15. Communicate nitrogen source 76 with diffuser 82 by opening valve 86 in order to very quickly pump up, or backfill, the loadlock chamber 14.

16. As sensor 90 detects a pressure approaching atmospheric pressure in the loadlock chamber 14, valves 46a, 46b are again actuated, as described above, to equalize the pressure on the wafers.

17. When atmospheric pressure is reached in the loadlock chamber 14, valve 32 is opened.

18. Another atmospheric exchange initiates a repeat cycle of steps 1-17.

A conventional pressure relief valve 92 is provided to prevent overfilling of chamber 14 during the pump up operation.

To assist in preventing motion of the wafers during the backfill of the loadlock chamber 14, means are arranged within the loadlock chamber 14 to create a laminar flow therein during the backfill or repressurization stage. In one exemplifying embodiment, the laminar flow means comprise a diffuser 82 arranged at an end of the conduit 79. Diffuser 82 has one or more specially constructed openings designed to create a laminar, rather than turbulent, flow in the loadlock chamber 14 when the nitrogen gas from source 76 is rapidly introduced into the loadlock chamber 14. By creating a laminar flow, the loadlock chamber 14 can be very quickly backfilled without causing turbulence therein and, thus, without creating any movement of the wafers on the paddles 26.

Diffuser 82 is preferably a tube having one end pointing into chamber 14. A laterally facing opening, or nozzle, is provided in the sides of the tube in communication with conduit 79. Diffuser 82 is preferably placed above the paddles and near a wall of the chamber 14. Thus, as the nitrogen is ejected from the nozzles, it tends to swirl around the periphery of the chamber. This effect is enhanced if the diffuser is positioned at a corner of the chamber. Furthermore, by positioning the diffuser above the paddles, the nitrogen enters above the wafers and this minimizes the creation of lift which might cause the wafers to float. Also, by positioning the diffuser at a side of the chamber, the laterally-directed forces created by the entering nitrogen encounters the very small surface area formed by the thin edge of the wafer to, thereby, apply only minimal laterally-directed forces to the wafer.

Although the detailed description provided above discusses specific embodiments of the present invention, various modifications thereto will be readily apparent to anyone with ordinary skill in the art. For example, vacuum source 40 can be replaced by communicating the paddles with the roughing pump 56. In such a case, for some step sequences, the pressure created at openings 38 and applied to the bottom of the wafers may exceed the pressure in chamber 14. If so, a check valve may be needed to prevent the pressure below the wafers from exceeding the pressure in the loadlock chamber 14, or else the wafer would float. Also, stand 29 of the paddles can be horizontal. Also, a turbo pump could be used that need not be coupled to a roughing pump. Also, valve 80 can be separated from chamber 12 by the floating platform 13. Furthermore, a single loadlock chamber is shown and described for use with a single inspection chamber. Can the invention be applied in wafer handling and transfer systems including multiple loadlock chambers with a single inspection chamber or multiple loadlock chambers with multiple inspection chambers. One or more of the loadlock chambers in such systems could incorporate any or all of the aspects of the invention disclosed above. Also, conduit 44 leading to openings 38 in paddle 26 can be implemented in many ways. For example, conduit 44 need not be a passage within the paddle. It can be a line running alongside stand 27 of the paddle. In addition, a pressure sensor other than 90 can be used for step 10. Moreover, various designs can be used for diffuser 82. All such modifications are intended to fall within the scope of the present invention as defined by the following claims.

I claim:

1. A semiconductor wafer holding system for holding wafers in position within a transfer chamber during transfer of the wafers between ambient atmosphere and an inspection chamber which is at vacuum pressure, comprising:
a transfer chamber interposed between the ambient atmosphere and the inspection chamber and subjected to alternating depressurization and repressurization;
at least one paddle arranged in said transfer chamber, and having a wafer-receiving surface having with openings therein adapted to be covered by a wafer; and
drawing means for drawing the wafer to said wafer-receiving surface of said at least one paddle to thereby inhibit motion of the wafer in said transfer chamber during at least one of the pressurization and depressurization.

2. The system of claim 1, wherein said drawing means are arranged to provide a pressure at said openings which is lower than pressure prevailing in said transfer chamber.

3. The system of claim 1, wherein said drawing means comprise a vacuum source or pump, and conduit means for providing flow communication between said vacuum source or pump and said openings to create suction thereat.

4. The system of claim 3, wherein said drawing means further comprise valve means operatively arranged with said conduit means for opening and closing the flow communication between said vacuum source or pump and said openings.

5. The system of claim 4, wherein said conduit means comprise a respective conduit leading to each of said at least one paddle, and said valve means comprise a respective valve operatively arranged with each said conduit.

6. The system of claim 5, wherein said valve means includes a flow connection to an interior of said transfer chamber to controllably communicate said openings with the interior of said transfer chamber.

7. The system of claim 5, wherein said drawing means further comprise paddle conduits arranged in each of said at least one paddle in flow communication with said openings in said paddle.

8. The system of claim 1, wherein said at least one paddle comprises two paddles.

9. The system of claim 8, wherein said drawing means comprise a vacuum source or pump, paddle conduits arranged in each of said paddles, first and second branch conduits each arranged between said vacuum source or pump and said paddle conduits in a respective one of said first and second paddles, and first and second valves operatively arranged with a respective one of said first and second branch conduits for opening and closing flow communication between said vacuum source or pump and said openings in the respective one of said first and second paddles.

10. The system of claim 1, further comprising laminar flow means for introducing a laminar flow of gas into said transfer chamber to repressurize said transfer chamber.

11. The system of claim 10, wherein said laminar flow means comprise a diffuser arranged in said transfer chamber and having at least one opening through which the gas is introduced into said transfer chamber.

12. The system of claim 1, further comprising valves for sealing said transfer chamber from the ambient atmosphere and the inspection chamber during depressurization and repressurization of said loadlock chamber.

13. A semiconductor wafer holding system for holding wafers in position during transfer of the wafers between ambient atmosphere and an inspection chamber which is at vacuum pressure, comprising:
a transfer chamber interposed between the ambient atmosphere and the inspection chamber and subjected to alternating depressurization and repressurization;
a paddle arranged in said transfer chamber, and having a wafer-receiving surface with openings therein adapted to be covered by a wafer;
a vacuum source or pump;
a conduit coupling said vacuum source or pump in flow communication with said openings; and
at least one valve operatively arranged in said conduit, whereby actuation of said at least one valve controls said flow communication so that when the pressure at said openings is less than the pressure prevailing in said transfer chamber, the wafer is drawn to said wafer-receiving surface of the paddle to thereby inhibit motion of the wafer in said transfer chamber.

14. The system of claim 13, wherein said valve means includes a flow connection to an interior of said transfer chamber to controllably communicate said openings with the interior of said transfer chamber.

15. The system of claim 13, wherein said conduit comprises a paddle conduit arranged in said paddle in flow communication with said openings in said paddle.

16. The system of claim 13, further comprising a diffuser arranged in said chamber and having at least one opening through which a laminar flow of gas is introduced into said transfer chamber to repressurize said transfer chamber.

17. A method for inhibiting motion of a semiconductor wafer in a transfer chamber subjected to alternating depressurization and repressurization, comprising:
arranging a paddle in the transfer chamber, the paddle having a wafer-receiving surface with openings therein;
placing the wafer on the wafer-receiving surface of the paddle, and over the openings;
coupling the openings in flow communication with a vacuum source or pump; and
controlling the flow communication between the vacuum source or pump and the openings during at least one of the depressurization and repressurization of the transfer chamber to cause the wafer to be drawn to the wafer-receiving surface of the paddle by a vacuum force and thereby inhibit motion of the wafer in the transfer chamber.

18. The method of claim 17, wherein the step of coupling the openings to a vacuum source or pump comprises providing a conduit between the vacuum source or pump and the openings, and said control of flow communication between the vacuum source or pump and the openings comprises operatively arranging a valve with the conduit.

19. The method of claim 17, further comprising closing the flow communication between the vacuum source or pump and the openings when the pressure in the depressurized transfer chamber rises to near atmospheric pressure.

20. The method of claim 17, further comprising introducing a laminar flow of gas into the transfer chamber during repressurization of the transfer chamber.

21. The method of claim 20, wherein the step of introducing gas into the transfer chamber comprises arranging a diffuser in the transfer chamber and providing the diffuser with at least one opening through which the gas is introduced into the transfer chamber.

22. A method for transferring semiconductor wafers between ambient atmosphere and an inspection chamber, maintained at a vacuum pressure, through a transfer chamber, comprising:
transferring a wafer from the ambient atmosphere through a first gate valve onto a paddle in the transfer chamber while the transfer chamber is isolated from the inspection chamber by a closed second gate valve;
closing the first gate valve to isolate the transfer chamber from the ambient atmosphere after the first wafer has been placed onto the paddle;
depressurizing the transfer chamber until the pressure in the transfer chamber is near the pressure in the inspection chamber, and then opening the second gate valve;
transferring the wafer from the transfer chamber to the inspection chamber after the second gate valve is open;
inspecting the wafer and then returning the inspected wafer to the paddle in the depressurized transfer chamber;
closing the second gate valve and, while the second gate valve is closed, repressurizing the transfer chamber;
providing the paddle with a wafer-receiving surface having openings therein, the wafer being placed on the paddle and over the openings therein;
coupling the openings in flow communication with a vacuum source or pump; and
controlling the flow communication between the vacuum source or pump and the openings during at least one of the depressurization and repressurization of the transfer chamber to cause the wafer to be drawn to the wafer-receiving surface of the paddle by suction and thereby inhibit motion of the wafer during said at least one of the depressurization and repressurization of the transfer chamber.

23. The method of claim 22, wherein said coupling of the openings to a vacuum source or pump comprises providing a conduit between the vacuum source or pump, and the step of controlling flow communication between the vacuum source or pump and the openings comprises operatively arranging a valve with the conduit.

24. The method of claim 22, further comprising the step of stopping the flow communication between the vacuum source or pump and the openings when the pressure in the depressurized transfer chamber rises to near atmospheric pressure.

25. The method of claim 24, further comprising the step of enabling flow communication between an interior of the transfer chamber and the openings as the flow communication between the vacuum source or pump and the openings is stopped.

26. The method of claim 22, wherein the step of repressurizing the transfer chamber comprises the step of introducing a laminar flow of gas into the transfer chamber.

27. A method for transferring semiconductor wafers between ambient atmosphere and an inspection chamber, maintained at a vacuum pressure, through a transfer chamber, comprising:
transferring a first wafer from the ambient atmosphere through a first gate valve onto a first paddle in the transfer chamber while the transfer chamber is isolated from the inspection chamber by a closed second gate valve;
closing the first gate valve to isolate the transfer chamber from the ambient atmosphere after the first wafer has been placed onto the paddle;
depressurizing the transfer chamber until the pressure in the transfer chamber is near the pressure in the inspection chamber, and then opening the second gate valve;
transferring the first wafer from the transfer chamber to the inspection chamber after the second gate valve is open;
closing the second gate valve and, while the second gate valve is closed, placing the first wafer onto a measurement site in the inspection chamber, repressurizing the transfer chamber, opening the first gate valve, placing a second wafer onto a second paddle in the transfer chamber, closing the first gate valve and depressurizing the transfer chamber;
opening the second gate valve and, while the second gate valve is open, transferring the first wafer from the inspection chamber onto the first paddle in the transfer chamber, and transferring the second wafer from the transfer chamber to the inspection chamber;
closing the second gate valve and, while the second gate valve is closed, placing the second wafer onto a measurement site in the inspection chamber, repressurizing the transfer chamber, opening the first gate valve, placing a third wafer onto the first paddle in the transfer chamber, closing the first gate valve and depressurizing the transfer chamber;
providing the first and second paddles with a wafer-receiving surface having openings therein, the wafers being placed on the first and second paddles, and over the openings;
coupling the openings in flow communication with a vacuum source or pump; and
controlling the flow communication between the vacuum source or pump and the openings during at least one of the depressurization and repressurization of the transfer chamber to cause the wafer to be drawn to the wafer-receiving surface of the paddle by suction and thereby inhibit motion of the wafer during said at least one of the depressurization and repressurization of the transfer chamber.

28. The method of claim 27, wherein said coupling of the openings to a vacuum source or pump comprises providing a conduit between the vacuum source or pump, and the step of controlling flow communication between the vacuum source or pump and the openings comprises operatively arranging a valve with the conduit.

29. The method of claim 27, further comprising the step of stopping the flow communication between the vacuum source or pump and the openings when the pressure in the depressurized transfer chamber rises to near atmospheric pressure.

30. The method of claim 29, further comprising the step of enabling flow communication between an interior of the transfer chamber and the openings as the flow communication between the vacuum source or pump and the openings is stopped.

31. The method of claim 27, wherein the step of depressurizing the transfer chamber comprises the steps of opening a roughing valve operatively associated with the transfer chamber for depressurizing the chamber, measuring the pressure in the transfer chamber during depressurization and, when the measured pressure approaches 10E-3 Torr, closing the roughing valve and opening a turbo molecular vacuum pump to depressurize the transfer chamber to a pressure of about 10E-6 Torr.

32. The method of claim 31, further comprising the steps of:
enabling flow communication between the vacuum source or pump and the openings until the pressure in the depressurized transfer chamber rises to near atmospheric presesure; and then
enabling flow communication between an interior of the transfer chamber and the openings.

33. The method of claim 27, wherein the step of repressurizing the transfer chamber comprises the step of introducing a laminar flow of gas into the transfer chamber.

34. The method of claim 33, wherein the step of introducing gas into the transfer chamber comprises the steps of operatively arranging a diffuser in the transfer chamber, and providing the diffuser with at least one opening through which the gas is introduced into the transfer chamber.

35. A semiconductor wafer holding system for holding wafers in a transfer chamber during transfer of the wafers between ambient atmosphere and an inspection chamber which is at vacuum pressure, comprising:
a transfer chamber interposed between the ambient atmosphere and the inspection chamber and subjected to alternating depressurization and repressurization;
a paddle arranged in said transfer chamber, said paddle having a wafer-receiving surface; and
laminar flow means for introducing a laminar flow of gas into said transfer chamber to repressurize said transfer chamber to thereby inhibit motion of any wafers during repressurization.

36. The system of claim 30, wherein said laminar flow means comprise a diffuser operatively arranged in said transfer chamber and having at least one opening through which the gas is introduced into said transfer chamber.

37. The system of claim 36, further comprising a source of gas, a conduit leading from said gas source to said diffuser and a valve operatively arranged with said conduit for regulating flow of gas from said gas source to said diffuser.

38. The system of claim 36, wherein said at least one opening in the diffuser is positioned above the paddle.

39. The system of claim 38, wherein said at least one opening in the diffuser is directed to create flow transversely within the transfer chamber.

40. The system of claim 39, wherein said at least one opening in the diffuser is positioned adjacent a wall of the transfer chamber.

41. The system of claim 40, wherein said at least one opening in the diffuser is positioned in a corner of the transfer chamber.

42. The system of claim 41, wherein said wafer-receiving surface of said paddle has openings adapted to be covered by the wafer, the system further comprising drawing means for drawing wafers to said wafer-receiving surface of said paddle by providing pressure at said openings which is lower than the pressure prevailing in said transfer chamber to thereby inhibit motion of any of the wafers in said transfer chamber.

43. The system of claim 42, further comprising a second paddle, and drawing means for drawing wafers to said wafer-receiving surface of said paddles to thereby inhibit motion of the wafer in said transfer chamber, said drawing means comprising a vacuum source or pump, first and second branch conduits each arranged between said vacuum source or pump and said paddle conduits in a respective one of said first and second paddles, and first and second valves operatively arranged with a respective one of said first and second branch conduits for opening and closing the flow communication between said vacuum source or pump and said openings in the respective one of said first and second paddles.

44. The system of claim 36, wherein said at least one opening in the diffuser is directed to create flow transversely within the transfer chamber.

45. The system of claim 36, wherein said at least one opening in the diffuser is positioned adjacent a wall of the transfer chamber.

46. The system of claim 36, wherein said at least one opening in the diffuser is positioned in a corner of the transfer chamber.

47. A method for inhibiting motion of a semiconductor wafer in a transfer chamber during repressurization of the transfer chamber, comprising the steps of:
arranging a paddle in the transfer chamber;
placing the wafer on a wafer-receiving surface of the paddle; and
introducing a laminar flow of gas into the transfer chamber during repressurization of the transfer chamber to thereby inhibit motion of the wafer during repressurization of said transfer chamber.

48. The method of claim 47, wherein the step of introducing gas into the transfer chamber comprises the steps of arranging a diffuser in connection with the transfer chamber and providing the diffuser with openings through which the gas is introduced into the transfer chamber.

49. The method of claim 47, further comprising the steps of:
arranging openings in the wafer-receiving surface of the paddle, the wafer being placed on the wafer-receiving surface of the paddle over the openings;
coupling the openings to a vacuum source or pump; and
selectively enabling flow communication between the vacuum source or pump and the openings during repressurization to cause the wafer to be drawn to the wafer-receiving surface of the paddle by suction.

50. The method of claim 49, wherein the step of coupling the openings to a vacuum source or pump comprises the step of providing a conduit between the vacuum source or pump, and the step of selectively enabling flow communication between the vacuum source or pump comprises the step of arranging a valve in connection with the conduit.

51. The method of claim 49, wherein flow communication between the vacuum source or pump and the openings is enabled upon the introduction of the gas into the transfer chamber.

52. A method for inspecting semiconductor wafers in an inspection chamber maintained at a vacuum pressure, comprising the steps of:
transferring a first wafer from the ambient atmosphere through a first gate valve onto a first paddle in a transfer chamber while the transfer chamber is isolated from the inspection chamber by a closed second gate valve;
closing the first gate valve to isolate the transfer chamber from the ambient atmosphere after the first wafer has been placed onto the paddle;
depressurizing the transfer chamber until the pressure in the transfer chamber is near the pressure in the inspection chamber and then opening the second gate valve;
removing the first wafer from the transfer chamber when the second gate valve is open;
closing the second gate valve and, while the second gate valve is closed, placing the first wafer onto a measurement site in the inspection chamber, repressurizing the transfer chamber, opening the first gate valve, placing a second wafer onto a second paddle in the transfer chamber, closing the first gate valve and depressurizing the transfer chamber;
opening the second gate valve and while the second gate valve is open, transferring the first wafer from the inspection chamber onto the first paddle in the transfer chamber and removing the second wafer from the transfer chamber; and
closing the second gate valve and, while the second gate valve is closed, placing the second wafer onto a measurement site in the inspection chamber, repressurizing the transfer chamber, opening the first gate valve, placing a third wafer onto the first paddle in the transfer chamber, closing the first gate valve and depressurizing the transfer chamber;
the step of repressurizing the transfer chamber comprising the step of introducing gas into the transfer chamber while creating a laminar flow in the transfer chamber.

53. The method of claim 52, wherein the step of introducing gas into the transfer chamber comprises the steps of arranging a diffuser in connection with the transfer chamber and providing the diffuser with openings through which the gas is introduced into the transfer chamber.

54. The method of claim 52, further comprising the steps of:
providing the first and second paddles with a wafer-receiving surface having openings therein, the wafers being placed on the first and second paddles over the openings;
connecting the openings to a vacuum source or pump; and
selectively enabling flow communication between the vacuum source or pump and the openings during at least one of the depressurization and repressurization of the transfer chamber to cause the wafer to be drawn to the wafer-receiving surface of the paddle by suction and thereby inhibit motion of the wafer during said at least one of the depressurization and repressurization of the transfer chamber.

55. The method of claim 54, wherein the step of connecting the openings to a vacuum source or pump comprises the step of providing a conduit between the vacuum source or pump, and the step of selectively enabling flow communication between the vacuum source or pump comprises the step of arranging a valve in connection with the conduit.

56. The method of claim 54, further comprising the step of stopping the flow communication between the vacuum source or pump and the openings when the pressure in the depressurized transfer chamber rises to near atmospheric pressure.

57. The method of claim 56, further comprising the step of enabling flow communication between an interior of the transfer chamber and the openings after the flow communication between the vacuum source or pump and the openings is closed.
